(19) United States
(12) Patent Application Publication
(10) Pub. No.: US 2004/0064553 A1
(43) Pub. Date: Apr. 1, 2004

(54) Computer network solution and software product to establish error tolerance in a network environment

(76) Inventor: Rikard M. Kjellberg, Santa Cruz, CA (US)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 10/622,319

(22) Filed: Jul. 18, 2003

Related U.S. Application Data
(63) Continuation of application No. PCT/SE02/00092, filed on Jan. 18, 2002.

(30) Foreign Application Priority Data
Jan. 19, 2001 (SE) 0100148-6
Feb. 19, 2001 (SE) 0100530-5

(51) Int. Cl. G06F 15/173

(52) U.S. Cl. 709/224

(57) ABSTRACT

A method for establishing error tolerance in a processing system is described. Error tolerance has been advanced by allowing autonomous processes to dynamically assign themselves unique, platform-independent identities upon their creation. The invention allows for the automated creation of backup processes, which automatically replace existing primary processes that have disappeared. Each individual process maintains surveillance of other processes. If one process is lost, the other processes are independently advised of this occurrence, allowing them to replace the lost process. The invention further provides for the consistent flow of backup processes based on each type of service. If a predetermined period of time lapses without a response from a primary process, one of the backup processes, which is of the same service type, will quickly replace the lost process. This backup process, which has now become a primary process, is replaced with a newly created backup process.

This is a continuation of international patent application no. PCT/SE02/00092 filed on Jan. 18, 2002 under the Patent Cooperation Treaty (PCT), which claims priority to Swedish patent application no. 0100148-6 filed on Jan. 19, 2001 and Swedish patent application no. 0100530-5 filed on Feb. 19, 2001.

### FIELD OF THE INVENTION

The present invention relates to the field of computer networks and fault tolerance systems. In particular the present invention discloses a method and system for automatically creating standby processes within a computer network in order to provide backup support in the case where a primary process is lost or removed from the system.

### BACKGROUND OF THE INVENTION

It is well known within the present technical field that distributed server architectures are commonly used such as a Local Area Network. Distributed server architectures and software processes have been used for a long time, within one or more hardware modules as well as the use of a master supervisor, to watch over all system processes. The traditional way for a master to supervise existing processes and resources, in distributed server architectures, requires each process or resource to send a multi-cast “ping” to the master to announce its existence and status.

A commonly used system for providing the above process is Sun Microsystems' server architecture known as “Jini”. Jini is a self-configuring, distributed server architecture, which has properties that support plug-n-play functionality. Jini networks contain a Jini server, which forms the implementation of a look-up service, which operates as a master. Jini networks may comprise a plurality of Jini servers in order to structure the resources of the network participants or to implement error tolerance in the master function. In addition to the Jini server, Jini networks usually comprise other participants such as: storage units, printers, PC's, other servers, etc.

As soon as a new participant (i.e. a hardware component or process) connects to the network, it sends a broadcast message to the look-up service in order to make its presence known to the network. The look-up service replies with an RMI Proxy, which allows the participant to register its interface with the look-up service. Accordingly, the new interface is added to a resource table within the look-up service, which other clients can access. A client, such as a PC, may requests a service (e.g. printer) by accessing the resource table of the look-up service. Hence, the PC becomes a client and the printer acts as a server by supplying printing services.

It should be noted that participants contained in the look-up service table are required to constantly ping the look-up service in order to notify the master of its continuous presence within the system. If this pre-determined ping interval is not met by a given resource, its process is dismissed from the resource table.

Conventional service systems, as known from the prior art, have a number of well-known problems. These problems are based on the basic system architecture mentioned above and are difficult to remedy. Thus, the prior art involves problems such as: bottlenecks, single-points-of-failure, lack of error correction, static capacity, static configuration, static types of services and static architecture.

Bottlenecks are the single greatest problem that occurs in typical distributed server architectures since all communications must travel through the master. This implies that a bottleneck can arise when too much network traffic is forced to funnel through the same place.

Single-point-of-failure occurs when the master disappears from the network. The entire system stops working because all extraneous resources are dependent on the master. This indicates that failure at a single place can lead to failure of the entire network.

Lack of error correction occurs in conventional server systems since they have no intrinsic capacity to remedy errors automatically. If a server crashes, the overall system remains with one less resource. Error correction usually requires manual intervention by network administrators. Hence, critical systems require continuous supervision and maintenance, which can be costly.

Static capacity can occur during increased workload. The system is unable to provide the necessary resources to handle increased loads. Handling this increase in capacity requires manual intervention to physically add more resources to combat the increased load. Again, such manual intervention and continuous supervision can be costly.

Static configuration exists in the prior art such that installing new resources require manual configuration. Such configuration is first done locally and thereafter centrally in order for the new resource's presence to become known by the master. This process is often complicated and work intensive.

Static service types are another common problem with distributed systems. The problems lie in the identification of these different types of services or jobs. For example, a printer must be identified as a server when it executes printing requests. A conventional way to handle service identification is to set up an organization or institution, which is responsible for allocating the identities to different service types. If an operator develops a new type of service, he must apply for a new, unique service-ID for the organization. Before this new service or job becomes compatible with its environment (i.e. able to work together with products from other operators), its identity and interface must be hard coded into the system. This complicated process results in incompatibilities between different products, even though open environments are desirable (at least by the users).

Under a static architecture, redundancy and scalability of a network must be administered manually. Furthermore, processes are partially identified by their physical address such that they cannot take their identities and migrate to other hardware modules. Child processes (threads) cannot be independently broken away from their parent-level processes, because the parent solely owns and controls them. Only the parent-level process itself can deploy its respective child sub-processes.

One of the major problems with the prior art is attributed to the lack of independent error tolerance. The purpose of independent error tolerance is to protect the entire system from problems if an individual component disappears in an uncontrolled way. Such tolerance is implemented by means of redundancy as a form of overcapacity. A system with built-in error tolerance contains active processes, which manage the nominal operation of a network. Active processes are given a status of primary. In addition to these primary processes, built-in redundancy exists in the form of passive processes, which do not participate in the nominal operations. Their function is to operate as reserve processes with a standby status.

If any primary processes shut down, an equivalent standby process (of the same type of service) shall replace the failing primary process. The standby process changes its status to primary and takes over the nominal operations of the failed process. Under such architecture, error tolerance is achieved and the system as a whole is not put out of operation due to the failure of a single component.

The concept of error tolerance is dynamic, however, this concept is restricted, because current server systems are based on static architecture. Hence the possibility of built-in dynamic functionality in a static environment has considerable limitations. An implementation of the primary/standby function in a static environment implies the following problems: Single-point-of-failure, static configuration, and no error correction.

In a single-point-of-failure system, a master supervises and controls the primary/standby function in the system. This implies that the master must discover a failing process and initiate an equivalent stand-by process. This means that the primary/standby function is dependent on the master. If the master or the connection between the master and the standby function were to disappear, the error tolerance would fail as well. Manual supervision and intervention would still be required.

“Hot-standby” is an implementation in which a primary process can be directly supervised by a corresponding standby process—a solution in which the master is completely avoided. But the problem with error tolerance still remains if the “hot-standby” process disappears. One solution might require several “hot-standby” processes, which supervise the same primary process. However, such an implementation still requires manual intervention when the numbers of “hot-standby” processes diminish over time.

Static configuration requires that configuration of primary and standby processes be done manually. Explicit declaration is required to state which process shall be primary and standby, as well as in which order the standby processes shall replace the primary processes upon failure. Static configuration is also required for “hot-standby” processes mentioned above. Such configuration is complex and requires manual supervision and intervention.

Lack of error correction can also be a problem when a primary process is lost and a standby process takes over, because the system now remains with one less resource. If the current domain only involved a single primary and standby process, there would be no standby process remaining and all error tolerance is void. This still requires manual supervision and intervention in order to restore the error tolerance.

The Jini architecture, described earlier, can be seen as a step in the right direction to solving some of the above identified problems of the prior art. Jini has been able to solve the some of the above-mentioned problems such as static configuration and static service types. Self-configuration and dynamic download service interfaces are excellent features but only handle two of the above problems.

As to error tolerance in distributed server environments, there are no known solutions that are adapted to distributed and autonomous network environments. In order to achieve error tolerance in such environments, processes must be able to handle error tolerance independently and without manual intervention.

### SUMMARY OF THE INVENTION

The invention consists of a method for providing fault tolerance in a processing system, the method comprising: removing the need for a centralized system to administer the responsibility of other processes; providing processes with autonomy such that processes have independent control over its actions; and allowing said processes to communicate together such that said processes are independently aware of the status of other processes.

### BRIEF DESCRIPTION OF THE DRAWINGS

A better understanding of the present invention can be obtained from the following detailed description in conjunction with the following drawings in which:

FIG. 1. illustrates the identification and registration of all participating processes and service types throughout a network whenever a newly created process enters the system;

FIG. 2. illustrates an exemplary method of admitting new processes into a network by reducing the probability of two processes simultaneously entering the system and sharing the same identification number;

FIG. 3. illustrates an exemplary method of assigning process identifications and service identifications to a new process entering a network; and

FIG. 4. illustrates an exemplary method of an autonomous process monitoring all other processes within a network in order to provide error tolerance against failed processes.

### DETAILED DESCRIPTION

The invention solves many of the problems that plagued the prior art such as: bottlenecks, single point of failures, lack of error correction, static capacity, static configuration, static service types and static architecture. The invention solves these problems by allowing processes to dynamically assign themselves unique, platform independent identities when they are created and introduced into a network. In short, the invention involves an autonomous process which: assigns itself a unique identity at startup, communicates directly with other processes in the system, updates itself continuously in response to other events in the system, maintains responsibility for its operations and status, and automatically adapts itself to changes in the system.

The invention removes the concern of bottlenecks that occur in traditional network systems because no master server is required to maintain and police all the processes in an autonomous architecture as described by the present invention. No longer must all requests funnel through a single master server. In an autonomous architecture, each process maintains complete independence from other resource in a network.

In addition to the elimination of bottlenecks, the present invention also solves the problem of a single point of failure. Since the present invention does not require the use of a master server, the probability of a single point of failure vanishes. Each process works independent of everything else, hence no common point of failure exists.

The present invention also solves the problem of error correction and tolerance. The dynamic communication environment is built on an IP-based multicast process. Once the process becomes active, it begins transmitting heartbeat messages onto the system's common multicast address (i.e. a broadcast transmission within the network's environment.) This heartbeat message is transmitted at predetermined time intervals (e.g. every second). This heartbeat message may contain relevant information about the process including: identity, port, service type, server type, status, and workload. The remaining processes within the network share the same capability to broadcast their own heartbeat messages as well as receive such messages from each other. Hence, each process is capable of maintaining its own list of processes.

Through the use of heartbeat messages, the above architecture allows for automated error correction. Each hardware component in a network contains a Service Activator (“SA”) that listens for heartbeat messages from other hardware components. If a hardware component stops sending a heartbeat message, the other components become aware of this change, whereby the Service Activator (SA) can automatically launch a new instance of the same service type as the process that ceased functioning. This results in dynamic error correction requiring no manual intervention. As old processes disappear or seize to function, new process are launched to take their place such that checks and balances are put in place to protect primary processes.

The problems of static capacity are also solved by the present invention. Load balancing, also known as daemons, can continuously direct tasks between different processes. Daemons, as well as all the other processes, maintain their own internal lists of resources. At any time, a daemon can redirect tasks to processes with low workloads. If a daemon discovers that an existing process is getting close to full load, it can instruct an SA to start up a new process and expand the system's available capacity. This functionality requires no manual intervention.

Static configuration is no longer a problem with the present invention. When new processes are introduced into a network, they immediately announce their presence through sending heartbeat messages. Through these heartbeat messages, all processes in the network can communicate with each other. This enables self-configuration by allowing each process to add, close, restart or even crash other processes without disturbing the nominal operation of the overall network environment. Processes can collaboratively decide which ones shall be primary and standby processes. No manual configuration is needed to make these processes known to each other or to set up a hierarchy of which processes act as standby and which ones act as primary.

The problems with static service types are solved by enabling the participating processes to dynamically and autonomously allocate themselves a suitable service type (based on a service ID). These processes also announce themselves to the system upon start up. Service IDs are associated with a service name of arbitrary format and length. However, the value is found in its ability to point to a URL, distributed object or program, which provides the interface for the current service. Thus each process provides the interface, which the overall environment needs in order to interact with a process. This method is dynamically accomplished on a component level.

Further, the present invention solves the problem of static architecture by enabling dynamic redundancy and scalability within and between hardware components throughout the system. Processes can migrate between hardware components because their identification number only identifies the process itself and not their physical address. Furthermore, a process can be divided into sub-processes, which can participate separately within the network environment. This enables sub-processes to be supervised and manipulated externally, without any need to go through related mother processes.

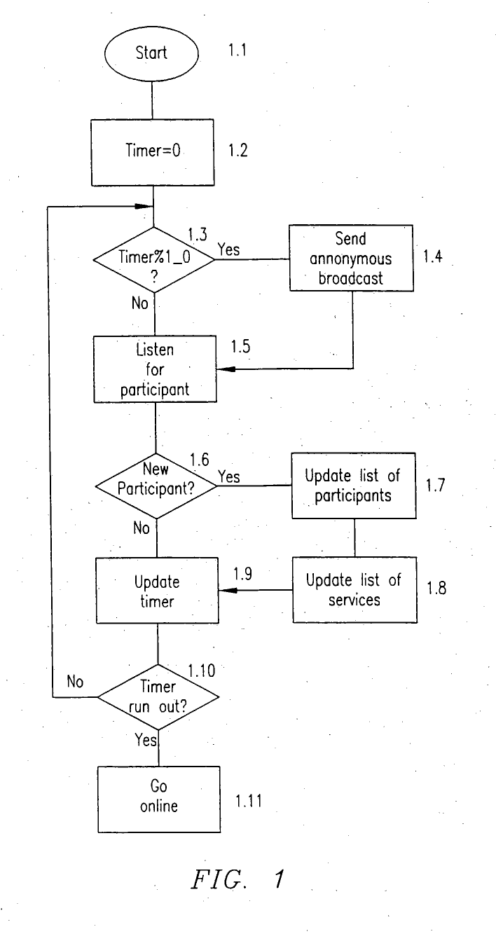

Elements of the present invention include an algorithm, an example of which is shown in FIG. 1, to identify and register all participating processes and service types throughout the network whenever a newly created process enters the system. FIG. 1 begins at start step 1.1 where a new process is installed and booted into a network environment according to the plug-and-play method. At step 1.2, the booted process accomplishes its first event by setting a timer parameter (“Timer”) to zero. Next, at step 1.3, the process tests to establish if the value of Timer is an even integer number (e.g. 0, 1, 2, 3 . . . n). If the value of Timer corresponds to an even integer number, then at 1.4, the process sends an anonymous broadcast message into the network environment requesting all participants in the network environment to report back by means of a heartbeat message.

In one embodiment, all participating processes already send heartbeat messages, (e.g. once a second), but some processes send heartbeat messages more or less frequent than others. Even though each process already sends heartbeat messages, they are instructed to immediately announce their identity once requested. For security reasons, the request of sending a heartbeat message is done every second.

Thereafter the new process goes online and begins listening at 1.5 to a multicast socket as well as listening to all incoming heartbeat messages from the existing processes in the network. These heartbeat messages contain information about process identification, service identification, status, workload, etc. As each heartbeat message is received, step 1.6 compares them to the existing list of processes to determine if a given heartbeat message was recently added or not. If a heartbeat message is new, step 1.7 will add it to the master list of process participants. Further, step 1.8 will add the new heartbeat message to the master list of services (which includes service identification numbers and names.) Next, step 1.9 updates Timer. In reference to 1.6, if a given heartbeat message is already contained in the master list of processes, steps 1.7 and 1.8 are bypassed and Timer is updated in step 1.9.

The subroutine contained in steps 1.3 through 1.9 are given a specific period of time in which to complete (e.g. three seconds). If this timeframe has not expired by the time the subroutine finishes, it will jump back to step 1.3 and begin again. For example, if the time accorded the subroutine is three seconds and the subroutine completes in 1.7 seconds, it will loop back to step 1.3 by incrementing Timer and continue to run through the remaining steps. When the subroutine returns to step 1.10, it will have exceeded the three-second timeframe (e.g. 1.7 seconds per pass=3.4 seconds). Once this occurs, the algorithm completes at step 1.11.

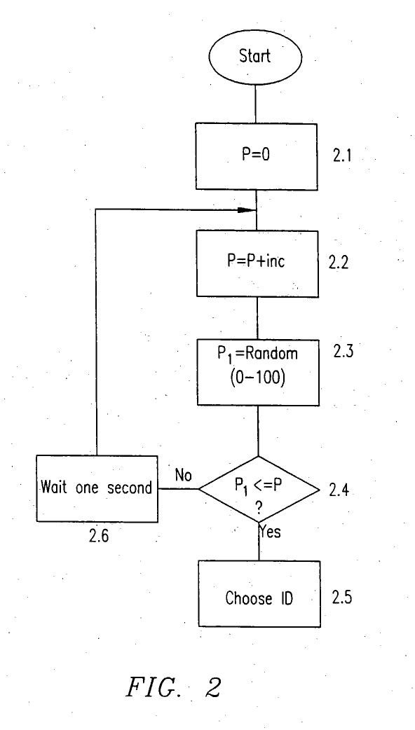

An example of the next algorithm of the claimed invention is illustrated in FIG. 2, which describes how the newly created processes from FIG. 1 are introduced into a network. FIG. 2 reduces the probability that two or more services, which concurrently enter a network, are accidentally assigned the same identification number. FIG. 2 solves this problem by spreading the admission of new processes over time. It should be noted that the risk that two processes are admitted at the same time interval, and share the same unoccupied identification number is believed to be approximately 1 out of 52*10⁻⁵. The algorithm in FIG. 2 further reduces the risk.

At step 2.1, an admission probability parameter (“P”) is set to zero. Then step 2.2 increments P by a default value (“inc”). In one embodiment, P could be defined to increase by 10% every time this step is repeated. In step 2.3, a number (“P1”) between 0 and 100 is randomly selected. In step 2.4, if P1 is less than the previously incremented P, the process will immediately enter the system. However, if P1 is greater than P (e.g. P has been incremented to 20% and the value of P1 is randomly set to 37), the process moves to step 2.6. Once in step 2.6, the process waits one second, and then returns to step 2.2 where P is incremented again by 10%. The process repeats steps 2.3 through 2.6 until P1 is less than or equal to P. The algorithm illustrated in FIG. 2 increases the probability that the maximum wait time for a new process is ten seconds (assuming “inc” is set to 10%). Under such a method, process admissions are spread over time when several of them are concurrently created. It should be noted that the parameters chosen above are not limited as such. Any specific time interval or random number range could be chosen without deviating from the present invention.

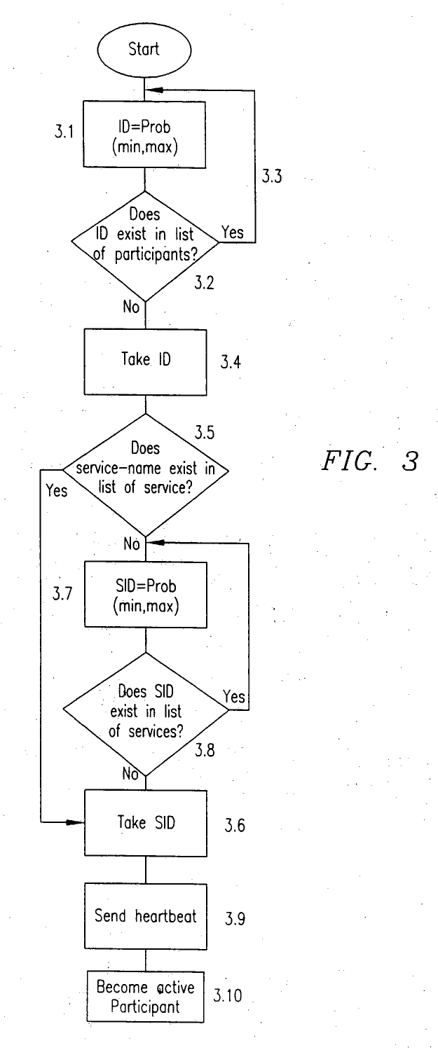

Once a new process is admitted to a network, a unique process identification (“PID”) and service identification (“SID”) must be assigned in order for the process to become an active participant in the network. An example of this algorithm is illustrated in FIG. 3. In step 3.1, a number between 0 and 256 is randomly selected. This number shall be tested as a possible PID. Thereafter in step 3.2, PID is compared with the identification numbers that already exist in the list of issued participants (FIG. 1). If PID is found in the list of issued participants, step 3.3 will loop the process back to step 3.1 to randomly select a new number. This procedure continues until the process finds an unoccupied PID. If the randomly selected PID is not occupied, step 3.4 allows the process to take this value, as it's unique PID. Those skilled in the art should know that 256 numbers is only one embodiment of the invention. Other minimum and maximum values could be used without altering the present invention.

In step 3.5, the service name of the process is compared with those already existing in the issued list of services (FIG. 1). If the service name already exists in the list of services (FIG. 1), step 3.6 allows the process to take this SID, which is already allocated to the current service name. If the service name does not exist in the list of services (FIG. 1), the process must allocate this service a unique SID (which is done in step 3.7). A number between 0 and 256 is randomly selected as a possible SID. Step 3.8 checks to see if the randomly selected SID already exists in the list of services (FIG. 1). If the SID has already been issued, the process returns to step 3.7 and repeats these steps until a new unique SID is found. Once a unique SID is found, the process moves to step 3.6 where it takes this SID.

It should be noted that a PID is unique for every process such that no two processes can share the same PID. However, SID's are only unique for each type of service, therefore two services providing the same service type would share the same SID. It should be known to one skilled in the art, that randomly selecting SIDs with numbers between 0 and 256 is only one embodiment of the invention. Other minimum and maximum values could be used without changing the present invention.

Under step 3.9, once the process has been assigned a unique PID and SID, the process announces its presence to the network by sending its own heartbeat messages. Lastly in step 3.10, the process becomes active in the network environment and its PID and SID become registered by the other participating processes.

### Error Tolerance

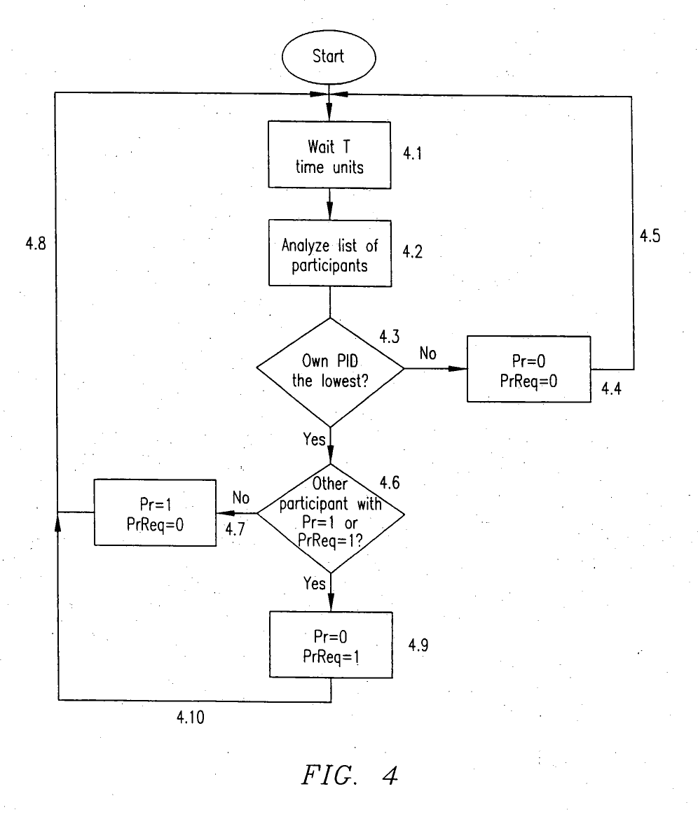

Once a process has been assigned a unique PID and SID and has been introduced into a network, the process becomes an active participant in the network environment. At this point, the process adopts the primary/standby algorithm taught above, and continuously executes the routine, which is exemplarily illustrated in FIG. 4. As processes disappear, new ones are created and replace them, such that no manual intervention is required.

In step 4.1, the process waits a certain number of time units (“T”). Once T runs out, the list of process participants is analyzed in step 4.2. It should be noted that each autonomous process keeps its own internal list of process participants, which is continuously updated by incoming heartbeat messages from the other processes (FIG. 1). The complete list of process participants comprises information about all the processes in the network environment such as: PID, SID, workload, status (primary or standby), etc. In regards to step 4.2, it should be noted that the analysis of the list of participants also includes the removal of “dead” processes. As an example, each process could have a time-out parameter that is three times the duration of the heartbeat frequency. If the heartbeat frequency of a process is once per second and no heartbeat is received after three seconds, the process is removed from the list of participants.

In step 4.3, the current process checks if it has the lowest PID among the active processes which supply the same service (i.e. have the same SID) and participate in the primary/standby function. If the current process does not have the lowest PID, step 4.4 automatically places the process into standby status by setting the primary parameter to zero (Pr=0) as well as setting a primary-request flag to zero (PrReq=0). Next, step 4.5 loops the current process to the beginning of FIG. 4 and allows the process to follow the same steps until it has the lowest PID.

If the current process does has the lowest PID, it moves to step 4.6 where a determination is made whether another process is already assigned as primary (Pr=1) or is flagged to become primary (PrReq=1). If no other processes are primary (Pr=1) or are flagged to become primary (PrReq=1), step 4.7 sets the values of the current process to Pr=1 and PrReq=0. This gives the current process a status of primary. Next, step 4.8 loops the process back to the beginning of FIG. 4 to start over, where the process continues this loop until another process takes over as primary. However, if another process is already primary (Pr=1) or is flagged to become primary (PrReq=1), the requesting process goes into standby by setting Pr=0, but they are also flagged to become primary by setting PrReq=1. This means that an existing primary process switches to standby so that the current requesting process can go to primary status. Once this occurs, step 4.10 loops the primary process back to the beginning of FIG. 4.

It should be understood that the waiting time in step 4.1 is not directly dependent on any other timing parameter that exists in the network environment. It is appropriate to choose a time interval T, which does not give an incoming process too much time in standby status.

It should also be noted that assigning processes a primary or standby status is only one embodiment. It is possible that a process is not assigned either status, and acts as solo process, such that manual intervention could allow for the assignment of this process to any service on a as needed basis. Also, a process should be free to ignore the algorithm in FIG. 4 and take over as a primary whenever it is required.

What is claimed is:

1. A method comprising:
maintaining a plurality of processes in a processing system, each with an ability to independently monitor a status of all of said plurality of processes, without the use of a master; and
enabling said plurality of processes to interact with each other to establish a priority of status, such that each of said plurality of processes can alter the priority of another of said plurality of processes without the use of a master to enable said interaction or alteration of priority.

2. A method as recited in claim 1, wherein said interaction and said alteration amongst said plurality of processes is used to enable fault tolerance for at least one of said processes in said processing system.

3. A method as recited in claim 1, wherein said status is one of: primary, to become primary, or standby.

4. A method as recited in claim 1, wherein said priority is based on a value of an identifier assigned to each of said plurality of processes.

5. A method as recited in claim 4, wherein said priority is further based on the status assigned to each of said plurality of processes.

6. A method for creating autonomy within a new process being admitted into a processing system, the method comprising:
enabling a new process to assign itself a unique, platform-independent identity, wherein an assignment of identity occurs at the time said new process is admitted into said processing system;
causing said new process to directly communicate with a plurality of process in the processing system;
enabling said new process to update a status in response to other events occuring in said processing system;
causing said new process to maintain a status in said processing system; and
causing said new process to adapt to changes in said processing system.

7. A method as recited in claim 6, wherein said status is one of: primary, to become primary, or standby.

8. A method as recited in claim 6, wherein a creation of autonomy within a new process allows for fault tolerance in a processing system without the need for a master.

9. A method for admitting a new process into a processing system, the method comprising:
admitting said new process into said processing system, such that a time at which said new process is admitted is based on whether one or more processes are being concurrently admitted with said new process;
causing said new process to broadcast a heart-beat message to notify each of a plurality of processes that said new process has been admitted into said processing system;
causing each of said plurality of processes to maintain a record identifying each of said plurality of processes; and
updating the record of each of said plurality of processes to include said new process.

10. A method as recited in claim 9, further comprising assigning said new processes a service type.

11. A method as recited in claim 9, wherein said heart-beat message broadcast by said new process includes an indentifier.

12. A method as recited in claim 9, wherein said heart-beat message broadcast by said new process includes a status.

13. A method as recited in claim 9, wherein said heart-beat message broadcast by said new process includes a workload.

14. A method as recited in claim 9, wherein a maintenance of a record by each of said plurality of processes is accomplished independent of each other.

15. A method for providing fault tolerance in a processing system, the method comprising:
enabling a plurality of processes in a processing system each to broadcast a heart-beat message, wherein said heart-beat message includes an identifier for each of said plurality of processes;
enabling each of said plurality of processes to receive said heart-beat message;
causing each of said plurality of processes to maintain an individual record of said plurality of processes;
causing each of said plurality of processes to update said individual record based on said heart-beat messages;
assigning each of said processes with a status, wherein said status is one of: primary, to become primary, or standby; and
enabling said plurality of processes to negotiate a hierarchy of control amongst each other based on the broadcast and receipt of heart-beat messages by each of said plurality of processes, wherein said hierarchy of control is based on the status of each of said plurality of processes.

16. A method recited in claim 15, wherein said heart-beat message further includes a service type.

17. A method recited in claim 15, wherein said heart-beat message further includes a workload.

18. The method recited in claim 15, wherein said negotiation between said plurality of processes allow for changing a status of one or more of said plurality of processes.

19. A method for providing fault tolerance for a process within a processing system, the method comprising:
maintaining a record of a plurality of processes in said processing system, wherein said plurality of processes are each assigned an identifier;
analyzing said record of processes to determine a priority for each process;
if one of said plurality of processes has a highest priority and no other of said plurality of processes has a status of primary or has been flagged to become primary, then assigning a status of primary to said process; and
if one of said plurality of processes has a highest priority and at least one other of said plurality of processes has a status of primary or has been flagged to become primary, then assigning a status of to become primary to said process.

20. A method recited in claim 19, wherein said priority is based on a value of said identifier.

21. A method recited in claim 19, wherein assigning of a status is based on a service type of said process.

22. A processing system comprising:
a computer, wherein said computer introduces a new process into a processing system such that said new process is assigned an identifier;
means for enabling said new process to broadcast a heart-beat message to said processing system;
means for causing a plurality of processes to receive, in said processing system, said heart-beat message, wherein said heart-beat message requests said plurality of processes to individually broadcast a heart-beat message;
means for causing each of said plurality of processes to broadcast an individual heart-beat message wherein said new process receives said individual heart-beat message during a time set by a timer;
means for causing each of said plurality of processes to maintain an individual record of processes wherein said record contains an identifier, a status, a service type and a workload of each of said plurality of processes;
means for causing said plurality of processes to establish a communication amongst each other, wherein said communication provides for an establishment of priority and status for each of said processes;
means for enabling said plurality of processes to replace one or more faulty processes; and
means for enabling said processing system to introduce one or more new processes.

23. The method recited in claim 22, wherein said broadcast of said heart-beat message includes a status.

24. The method recited in claim 22, wherein said broadcast of said heart-beat message includes an identifier.

25. The method recited in claim 22, wherein said broadcast of said heart-beat message includes a workload.

26. The method recited in claim 22, wherein said broadcast of said heart-beat message includes a service type.

27. The method recited in claim 22, wherein a replacement of one or more processes is based on the priority of each of said plurality of processes.

28. The method recited in claim 22, wherein an introduction of one or more new processes is based on a need for said new processes, wherein said need is based on a type of service.

29. A processing system comprising:
a plurality of processes, wherein each of said plurality of processes is able to independently monitor a status of each other of said plurality of processes, each of said processes communicating with each other to establish a priority of status such that at least one of said plurality of processes can change a status of each other.

30. The processing system recited by claim 29, wherein a master is not required to monitor and establish priority amongst said plurality of processes.

31. The processing system recited by claim 29, wherein said monitoring and establishment of priority amongst said plurality of processes is accomplished from the broadcasting of heart-beat messages.

32. The processing system recited by claim 29, wherein said monitoring and establishment of priority amongst said plurality of processes is used to enable fault tolerance for at least one of said processes in said processing system.

33. The processing system recited in claim 29, wherein said processing system comprises one or more computers.

34. The processing system recited in claim 29, wherein said communication between said plurality of processes does not require a master.

35. A processing system for providing fault tolerance, the processing system comprising:
a processor; and
a memory containing software which, when executed by the processor, causes the processing system to perform a process comprising:
enabling each of a plurality of processes to transmit an individual heart-beat message wherein said heart-beat message contains an identifier of said process;
causing each of said processes to receive said individual heart-beat message;
causing each of said processes to maintain a record of said plurality of processes based on the receipt of said individual heart-beat messages;
causing each of said plurality of processes to update said record based on said heart-message;
assigning each of said processes with a status wherein said status is one of: primary, to become primary, or standby; and
enabling said plurality of processes to negotiate a hierarchy of control amongst each other based on the broadcast and receipt of heart-beat messages by each of said plurality of processes wherein said hierarchy of control is based on the status of each of said plurality of processes.

36. The processing system recited in claim 35, wherein said individual heart-beat message further contains a status.

37. The processing system recited in claim 35, wherein said individual heart-beat message further contains a workload.

38. The processing system recited in claim 35, wherein said individual heart-beat message further contains a service type.

39. The processing system recited in claim 35, wherein said negotiation between said plurality of processes allows for changing a status of at least one of said plurality of processes.
